(19) United States
(12) Patent Application Publication
(10) Pub. No.: US 2025/0226605 A1
(43) Pub. Date: Jul. 10, 2025

(54) WIRING STRUCTURE AND SWITCHING DEVICE

(71) Applicant: Schneider Electric Industries SAS, Rueil-Malmaison (FR)

(72) Inventors: Zhiping Huan, Shanghai (CN); Yuanzhong Wang, Shanghai (CN); Haifeng Tian, Shanghai (CN); Zhen Li, Shanghai (CN); Cheng Huang, Shanghai (CN)

(73) Assignee: Schneider Electric Industries SAS, Rueil-Malmaison (FR)

(21) Appl. No.: 19/006,344

(22) Filed: Dec. 31, 2024

(30) Foreign Application Priority Data
Jan. 5, 2024 (CN) 2024200340835

(51) Int. Cl. H01R 12/75; H01R 13/621; H01R 13/631

(52) U.S. Cl. CPC H01R 12/75; H01R 13/6215; H01R 13/631

(57) ABSTRACT

A wiring structure includes: a housing; a wiring frame, movably arranged in the housing in an up-and-down direction; a wiring board, extending into the wiring frame from a first side perpendicular to the up-and-down direction, the wiring board being fixed relative to the housing; a bolt, penetrating through a top plate of the wiring frame and configured to drive the wiring frame to move upward through a downward rotary movement; an external wire, extending into the wiring frame from a second side opposite to the first side; and a flexible pressing piece, arranged between a bottom plate of the wiring frame and the wiring board, and abutting against the external wire and subjected to a downward pressure of the external wire upon the wiring frame moving upward, exerting an upward biasing force on the external wire and pressing the external wire between the wiring board and the flexible pressing piece.

The present application claims the priority and benefits of the Chinese Patent Applications No. 202420034083.5, which was filed on Jan. 5, 2024, the disclosure of which is incorporated herein by reference in its entirety as part of the present application.

### TECHNICAL FIELD

Embodiments of the present application relate to a wiring structure and a switching device including the wiring structure.

### BACKGROUND

In the process of using the existing wiring structure, due to the influence of various factors (such as temperature change, vibration and shock, creep of the external wire itself, etc.), the external wire may come loose, which will increase the contact impedance and cause failure. Therefore, it is needed to provide a structure for preventing external wires from loosening.

### SUMMARY

In order overcome the problems in the existing art, the present application provides a wiring structure, comprising: a housing; a wiring frame, movably arranged in the housing in an up-and-down direction; a wiring board, extending into the wiring frame from a first side perpendicular to the up-and-down direction, the wiring board being fixed relative to the housing; a bolt, penetrating through a top plate of the wiring frame and configured to drive the wiring frame to move upward through a downward rotary movement; an external wire, extending into the wiring frame from a second side opposite to the first side; and a flexible pressing piece, arranged between a bottom plate of the wiring frame and the wiring board, and configured to abut against the external wire and subjected to a downward pressure of the external wire upon the wiring frame moving upward, thereby exerting an upward biasing force on the external wire and pressing the external wire between the wiring board and the flexible pressing piece.

Advantageously, a part of the flexible pressing piece is fixedly installed on the bottom plate of the wiring frame, has a U-shaped form, and comprises a first leg, a second leg and a bending part connecting the first leg and the second leg, and the second leg is closer to the wiring board than the first leg,
the wiring frame comprises a transverse plate, the transverse plate is arranged between the first leg and the second leg and spaced apart from the first leg in the up-and-down direction, and the second leg is sandwiched between the external wire and the transverse plate.

Advantageously, a surface of the second leg adjacent to the external wire is provided with a plurality of protrusions protruding toward the external wire, and the plurality of protrusions are configured to abut against the external wire.

Advantageously, upon a connection of the external wire being loose and a gap being generated between the external wire and the second leg, the second leg moves upward under an action of an elastic force of the second leg, so as to abut against the external wire again, to press the external wire between the wiring board and the second leg.

Advantageously, the second leg is inclined, and an inclined direction of the second leg is designed such that a part of the second leg adjacent to the second side is closer to the external wire than a part of the second leg adjacent to the first side.

Advantageously, the wiring structure further comprises a rigid pressing piece arranged between the top plate of the wiring frame and the wiring board, and the rigid pressing piece is fixed to the bolt, upon another external wire extending between the rigid pressing piece and the wiring board from the second side, when the bolt rotates downward, the bolt drives the rigid pressing piece towards the another external wire, so that the bolt and the rigid pressing piece abut against the another external wire together.

Advantageously, a surface of the rigid pressing piece facing the another external wire is provided with a plurality of protrusions protruding towards the another external wire, and the plurality of protrusions are configured to abut against the another external wire.

The present application provides a switching device, comprising the abovementioned wiring structure.

### BRIEF DESCRIPTION OF DRAWINGS

The above and other features and advantages of the exemplary embodiments of the present disclosure will become more apparent from the following detailed description taken in conjunction with the accompanying drawings, which are for illustrative purposes only and are not intended to limit the scope of the present disclosure in any way, wherein:

FIG. 1 shows an external view of a wiring structure according to the present application installed to a switching device.

FIG. 2 shows a sectional view of a wiring structure according to the present application installed to a switching device, in which a bolt has not yet driven a wiring frame to move.

FIG. 3 shows a cross-sectional view of a wiring structure according to the present application installed to a switching device, in which a bolt has driven the wiring frame to move, so that an external wire is compressed.

FIG. 4 shows a cross-sectional view of a wiring structure according to the present application installed in a switching device, in which an external wire is loose, resulting in a gap between the external wire and a wiring board and/or a pressing piece.

FIG. 5 shows a cross-sectional view of a wiring structure according to the present application installed in a switching device, in which a flexible pressing piece is elastically deformed to press an external wire again.

### DETAILED DESCRIPTION

In order to make the purpose, technical details and advantages of the technical solution of the present disclosure more clear, the technical solution of the embodiment of the present disclosure will be described clearly and completely with the accompanying drawings of specific embodiments of the present disclosure. Like reference numerals in the drawings represent like parts. It should be noted that the described embodiment is a part of the embodiment of the present disclosure, not the whole embodiment. Based on the described embodiments of the present disclosure, all other embodiments obtained by ordinary people in the field without creative labor belong to the scope of protection of the present disclosure.

Compared with the embodiments shown in the attached drawings, the feasible embodiments within the protection scope of the present disclosure may have fewer components, other components not shown in the attached drawings, different components, components arranged differently or components connected differently, etc. Furthermore, two or more components in the drawings may be implemented in a single component, or a single component shown in the drawings may be implemented as a plurality of separate components.

Unless otherwise defined, technical terms or scientific terms used herein shall have their ordinary meanings as understood by people with ordinary skills in the field to which the present disclosure belongs. The words “first”, “second” and similar words used in the specification and claims of the patent application of the present disclosure do not indicate any order, quantity or importance, but are only used to distinguish different components. When the number of parts is not specified, the number of parts can be one or more; Similarly, similar words such as “one”, “the” and “said” do not necessarily refer to quantity limitation. Similar words such as “including” or “comprising” refers to that the elements or objects appearing before the word cover the elements or objects listed after the word and their equivalents, without excluding other elements or objects. Similar words such as “installation”, “setting”, “connection” or “connection” are not limited to physical or mechanical installation, setting and connection, but can include electrical installation, setting and connection, whether directly or indirectly. “Up”, “Down”, “Left” and “Right” are only used to indicate the relative orientation relationship when the equipment is used or the orientation relationship shown in the attached drawings. When the absolute position of the described object changes, the relative orientation relationship may also change accordingly.

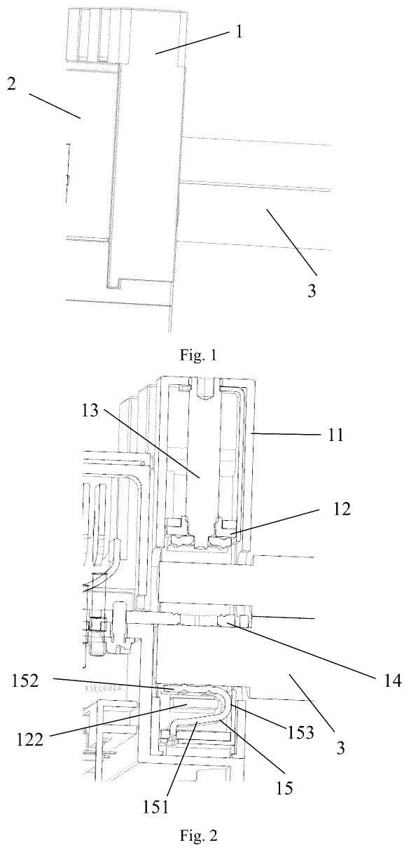

FIG. 1 shows an external view of a wiring structure 1 of the present application installed in a switching device 2, and an external wire 3 extends into the wiring structure 1.

FIG. 2 shows a cross-sectional view of a wiring structure 1 of the present application installed to the switching device 2. At this time, a bolt 13 does not drive the wiring frame to move. The wiring structure 1 includes a housing 11 in which components of the wiring structure are accommodated. The wiring structure 1 further includes a wiring frame 12 movably arranged in the housing 11 in an up-and-down direction, and a bolt 13 passes through a top plate of the wiring frame 12 and is configured to drive the wiring frame 12 to move upward through a downward rotational movement. A wiring board 14 is connected to an electrical terminal of the switching device 1, or the wiring board 14 is the electrical terminal of the switching device 1, which extends into the wiring frame 12 from a first side (the left side in the figure) perpendicular to the up-and-down direction, and the wiring board 14 is fixed relative to the housing 11. An external wire 3 extends into the wiring frame 12 from a second side (the right side in the figure) opposite to the first side.

A flexible pressing piece 15 is arranged between a bottom plate 121 of the wiring frame 12 and the wiring board 14 and configured to abut against the external wire 3 and subjected to a downward pressure of the external wire upon the wiring frame 12 moving upward, thereby exerting an upward biasing force on the external wire and pressing the external wire between the wiring board and the flexible pressing piece.

In the state shown in FIG. 2, the wiring frame 12 has not moved upward, so the flexible pressing piece has not pressed the external wire between the wiring board and the flexible pressing piece.

In an example of the present application, a part of the flexible pressing piece 15 is fixedly installed to the bottom plate of the wiring frame. As illustrated by FIG. 2, the flexible pressing piece has a U-shaped form, and includes a first leg 151, a second leg 152 and a bending part 153 connecting the first leg 151 and the second leg 152, and the second leg 152 is closer to the wiring board than the first leg 151. In the state of FIG. 2, the second leg 152 is not in contact with the external wire 3, that is, there is a gap between the second leg 152 and the external wire 3.

In addition, the wiring frame 12 includes a transverse plate 122, the transverse plate 122 is arranged between the first leg 151 and the second leg 152, and there is a gap between the transverse plate 122 and the second leg 152 in the state shown in FIG. 2.

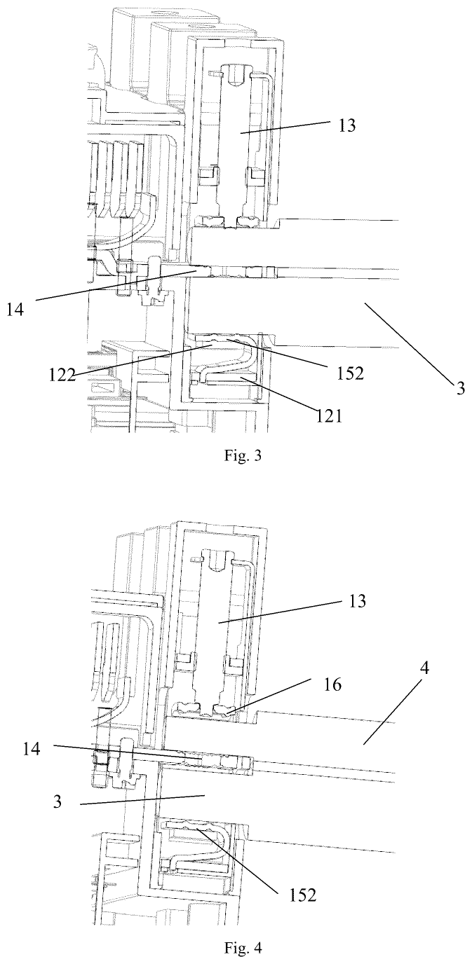

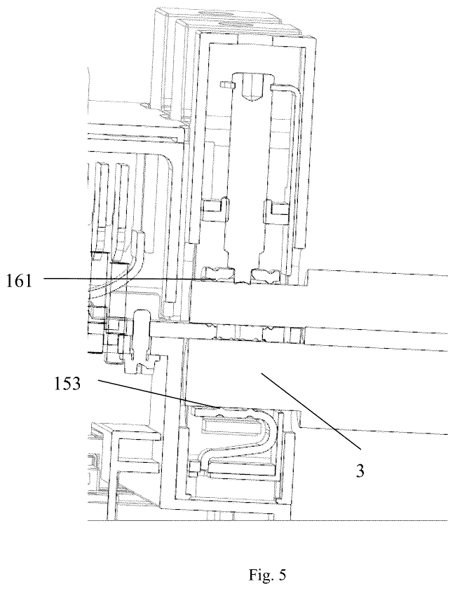

After rotating the bolt upward, the wiring frame 12 moves upward, which drives the flexible pressing piece 15 to move upward, causing the second leg 152 to abut against the external wire 3. After the external wire 3 abuts against the wiring board 14, the external wire 3 exerts an upward pressure on the second leg 152, causing the second leg 152 to deform downward and abut against the transverse plate 122. At this time, the external wire 3 is pressed between the wiring board 14 and the second leg 152, as illustrated by FIG. 3. At this time, the overall structure becomes rigid, not flexible. If the torque applied to the bolt is greater than the design torque, such torque will act on the wiring frame, but not on the flexible pressing piece, so that greater torque will not damage the flexible pressing piece.

The arrangement of the transverse plate 122 is mainly to control the downward deformation of the second leg 152, but it should be understood by those skilled in the art that the application can be implemented without the transverse plate 122, but the compression effect on the external wire 3 may not be as good as that of the embodiment with the transverse plate 122.

The surface of the second leg 152 adjacent to the wiring board 14 is provided with a plurality of protrusions 153 protruding toward the wiring board 14 for abutting against the external wire. These protrusions 153 can be pressed against the external wire and form pits on the external wire, which further prevents the external wire from being pulled out accidentally.

When the connection of the external wire 3 is loose, resulting in a gap between the external wire 3 and the second leg 152 (actually, the external wire 3 may also have a gap with the wiring board, but all the gaps may be equivalent to the gaps between the external wire 3 and the second leg 152), as illustrated by FIG. 4, the second leg 152 moves upward under the action of its elastic force, so as to abut against the external wire 3 again, thereby pressing the external wire between the wiring board 14 and the second leg 152 again. In this way, the external wire can still be pressed again when the external wire is loose.

Preferably, the second leg 152 is inclined, and the inclined direction of the second leg is designed such that a part of the second leg adjacent to the second side is closer to the external wire than a part of the second leg adjacent to the first side. Due to such an inclined structure, the external wire is further prevented from being pulled out accidentally.

The wiring structure 1 further includes a rigid pressing piece 16 arranged between the top plate of the wiring frame and the wiring board, which is fixed to the bolt 13 and can move together with the bolt 13. When another external wire 4 extends between the rigid pressing piece 16 and the wiring board from the second side, when the bolt 13 rotates downward, the bolt 13 drives the rigid pressing piece 16 to move toward the another external wire 4, so that the bolt and the rigid pressing piece abut against the another external wire 4 together and press the another external wire 4 against the wiring board.

As illustrated by the FIG. 4, the surface of the rigid pressing piece 16 facing the another external wire 4 is provided with a plurality of protrusions 161 protruding towards the another external wire 4, and the plurality of protrusions 161 are configured to abut against the another external wire 4. The plurality of protrusions 161 of the rigid pressing piece have the same function as the protrusions of the second leg.

In addition, although the present application describes a rigid pressing piece, this is only for the purpose of achieving a more uniform pressure on another external wire 4. Actually, it is also possible to press the another external wire 4 only by the bolt without a rigid pressing piece.

The application also provides a switching device including such a wiring structure.

Through the flexible pressing piece of the wiring structure provided by the invention, the external wire can be pressed again when the external wire is loose, and the loosening prevention function is realized.

Although the present disclosure has been described in the specification and illustrated in the drawings on the basis of referring to various embodiments, those skilled in the art can understand that the above-mentioned embodiments are only preferred embodiments, and some technical features in the embodiments may not be necessary for solving specific technical problems, so these technical features may not be needed or omitted without affecting the solution of technical problems or the formation of technical solutions. Moreover, the features, elements and/or functions of one embodiment can be combined, integrated or coordinated with those of one or more other embodiments as appropriate, unless the combination, integration or coordination is obviously impracticable.

1. A wiring structure, comprising:
a housing;
a wiring frame, movably arranged in the housing in an up-and-down direction;
a wiring board, extending into the wiring frame from a first side perpendicular to the up-and-down direction, the wiring board being fixed relative to the housing;
a bolt, penetrating through a top plate of the wiring frame and configured to drive the wiring frame to move upward through a downward rotary movement;
an external wire, extending into the wiring frame from a second side opposite to the first side; and
a flexible pressing piece, arranged between a bottom plate of the wiring frame and the wiring board, and configured to abut against the external wire and subjected to a downward pressure of the external wire upon the wiring frame moving upward, thereby exerting an upward biasing force on the external wire and pressing the external wire between the wiring board and the flexible pressing piece.

2. The wiring structure according to claim 1, wherein a part of the flexible pressing piece is fixedly installed on the bottom plate of the wiring frame, has a U-shaped form, and comprises a first leg, a second leg and a bending part connecting the first leg and the second leg, and the second leg is closer to the wiring board than the first leg,
the wiring frame comprises a transverse plate, the transverse plate is arranged between the first leg and the second leg and spaced apart from the first leg in the up-and-down direction, and the second leg is sandwiched between the external wire and the transverse plate.

3. The wiring structure according to claim 2, wherein a surface of the second leg adjacent to the external wire is provided with a plurality of protrusions protruding toward the external wire, and the plurality of protrusions are configured to abut against the external wire.

4. The wiring structure according to claim 3, wherein upon a connection of the external wire being loose and a gap being generated between the external wire and the second leg, the second leg moves upward under an action of an elastic force of the second leg, so as to abut against the external wire again, thereby pressing the external wire between the wiring board and the second leg.

5. The wiring structure according to claim 4, wherein the second leg is inclined, and an inclined direction of the second leg is designed such that a part of the second leg adjacent to the second side is closer to the external wire than a part of the second leg adjacent to the first side.

6. The wiring structure according to claim 1, wherein the wiring structure further comprises a rigid pressing piece arranged between the top plate of the wiring frame and the wiring board, and the rigid pressing piece is fixed to the bolt, upon another external wire extending between the rigid pressing piece and the wiring board from the second side, when the bolt rotates downward, the bolt drives the rigid pressing piece towards the another external wire, so that the bolt and the rigid pressing piece abut against the another external wire together.

7. The wiring structure according to claim 6, wherein a surface of the rigid pressing piece facing the another external wire is provided with a plurality of protrusions protruding towards the another external wire, and the plurality of protrusions are configured to abut against the another external wire.

8. A switching device, comprising the wiring structure according to claim 1.
